(19) United States
(12) Patent Application Publication
(10) Pub. No.: US 2020/0141735 A1
(43) Pub. Date: May 7, 2020

(54) INDOOR NAVIGATION SYSTEM AND METHOD THEREOF

(71) Applicant: Future Netwings Solutions Pvt. Ltd., Kolkata (IN)

(72) Inventor: Sabir Iqbal, Kolkata (IN)

(21) Appl. No.: 16/668,208

(22) Filed: Oct. 30, 2019

(30) Foreign Application Priority Data
Nov. 2, 2018 (IN) 201831041601

(51) Int. Cl. G01C 21/20; H04B 17/318; H04W 4/02; H04W 84/18; H04W 4/80

(52) U.S. Cl. CPC G01C 21/206; H04B 17/318; H04W 4/80; H04W 84/18; H04W 4/027

(57) ABSTRACT

In one embodiment, an indoor navigation system is disclosed. The indoor navigation system may comprise a user navigation device, a first network, a second network, a short-range network and a server. The server may be configured to receive RSSI data and floor metadata from a user navigation device. The user navigation device may be configured to receive the RSSI data from a subset of beacons of a set of beacons installed along a 3-dimensional area in a facility. Further, the server receives acceleration data from an accelerometer installed in the user navigation device. The server then determines the location coordinates of the user navigation device in the 3-dimensional area by processing the received RSSI data and the floor metadata based on acceleration data. Further, the server may the location coordinates to the user navigation device for generating navigation instructions for assisting the user to reach a destination location.

### CROSS REFERENCE TO RELATED APPLICATIONS

The present application claims the benefit of Indian Application No. 201831041601 filed on Nov. 2, 2018, the contents of which are incorporated herein by reference in their entirety.

### TECHNICAL FIELD

The present subject matter described herein, in general relates to an indoor navigation system. In particular, the present subject matter is related to a Bluetooth based indoor navigation system.

### BACKGROUND

The technological advancement in navigation systems has explored every aspect of human life. Technical evolution in navigation and location-based applications has extensively influenced the lifestyle of human being across various location related aspects and operations.

For the management of navigation related operations, there are many new navigation-based solutions which have been introduced with the emergence of the navigation technology. However, utilization of mobile applications combined with indoor navigation technologies are not unrolled sufficiently with respect to visitor and crowd facility management. It always remains a tedious task for a new comer to locate services and small indoor areas such as, a meeting room, a hospital room, a restroom, a pantry area, lighting control, authentication entry in an organization premises.

In another scenario, to facilitate the organized operations in offices and organizations, it is necessary to provide facility of navigation between asynchronized functioning areas such as office appliance locations, pantry location, department location, visitor management, safety management, and user identification etc.

Sometimes it becomes difficult for a visitor or personnel to navigate towards small distance locations and indoor objects such as printers, landline phones, conference rooms and locations as departments of office or stores in the mall, cafeteria, pantry and parking navigations by recalling the directions by a visitor or an employee from another department.

However, in the present scenario detection and locating of all such small distance locations in a multistory building or premises of any institution of organization in not possible by geo-positioning of a human being. The accurate navigation and positioning of a user is a complex task as the tolerance of distance scale is very small in case of indoor navigation and such difference in distance cannot be accurately captured by GPS based systems as the scale of distance in such application relates to a larger distance range. Further, in case of multi-height facilities, the present indoor positioning system does not give a clear indication of the exact location of the user at any instant. In addition, the existing indoor positioning and navigation system does not consider the height parameter of the moving user in the indoor environment, therefore the accuracy of indoor positioning of the user is compromised.

Furthermore, in the existing indoor navigation system, the user's location is obtained by utilizing a minimum of three beacons operating in an environment through the known triangulation and trilateration process. Therefore, the problem of indoor navigation persists in cases, when the 3-dimensional area (104) is an elongated narrow space, wherein the navigating the set by using less than three beacons seems an issue.

Therefore, there is a long felt need highly accurate platform for indoor navigation management system. Further, the need also exists for having the navigating system that operates on three set of beacons as well as less than three set of beacons, in scenarios where the 3-dimensional area (104) is an elongated narrow space or a rectangular or squared in shape.

### SUMMARY

This summary is provided to introduce concepts related to an integrated indoor navigation system. This summary is not intended to identify essential features of the claimed subject matter is not intended for use on determining or limiting the scope of the claimed subject matter.

In one embodiment, an indoor navigation system is disclosed. The system may comprise a user navigation device, a first network, a second network, a short-range network and a server. The server may comprise of a memory coupled with a processor, wherein the processor is configured to execute programmed instructions stored in the memory. The server may be configured to receive RSSI data and floor metadata from a user navigation device. The user navigation device may be configured to receive the RSSI data from a subset of beacons of a set of beacons. The set of beacons may be installed along a 3-dimensional area in a facility. Further, the server receives acceleration data from an accelerometer installed in the user navigation device. The server then determines the location coordinates of the user navigation device in the 3-dimensional area by processing the received RSSI data and the floor metadata based on acceleration data. After determining the location coordinates of the user navigation device, the server transmits the location coordinates to the user navigation device. The user navigation device, upon receipt of the location coordinates, may be configured to generate navigation instructions for assisting the user of the user navigation device to reach a destination location in the 3-dimensional area.

In another embodiment, a method for indoor navigation is disclosed. The method may comprise steps for receiving RSSI data and floor metadata from a user navigation device, wherein the user navigation device may be configured to receive the RSSI data from a subset of beacons of a set of beacons. The disclosed set of beacons may be installed along a 3-dimensional area in a facility. The method may comprise steps for receiving acceleration data from an accelerometer of the user navigation device. The method may comprise a third step of determining the location coordinates of the user navigation device in the 3-dimensional area by processing the received RSSI data and the floor metadata based on acceleration data. The method may comprise steps for determining the location coordinates of the user navigation device, the server transmits the location coordinates to the user navigation device. The user navigation device, upon receipt of the location coordinates, may be configured to generate navigation instructions for assisting the user of the user navigation device to reach a destination location in the 3-dimensional area.

In another embodiment, the server may be configured for BLE (Bluetooth Low Energy) based indoor navigation. The server may comprise a processor and a memory coupled with the processor. The processor may be configured to execute one or more modules stored in a memory. The one or more modules may comprise a setup and configuration module, a metadata analytics module, an indoor navigation module, fault tolerance module, positioning module and other modules. The other modules may comprise managing one or more interrelated tasks in the premises depending on location and proximity of the user device from the BLE beacon like indoor navigation, attendance management, and location-based behavior analysis etc.

In another embodiment, a method of BLE (Bluetooth low energy based indoor navigation is disclosed. The method may comprise a first step of selecting, via a program executed by a processor, a floor map for which a navigation is to be carried out. The method may comprise a second step of scanning and placing, via the program executed by the processor, the position coordinates of BLE beacons attached to the ceiling on the display of map. The method may comprise a third step of generating a floor metadata, via the program executed by the processor, wherein the floor metadata comprises area/zone data, proximity data, signal strength data in combination with position data. The method may comprise a fourth step of uploading, via the program executed by the processor, the generated metadata to the server communicatively coupled with the processor. The method may comprise a fifth step of downloading, via the program executed by the processor, the floor metadata from server to the user navigation device. The method may comprise a sixth step of searching and obtaining, via the program executed by the processor, BLE beacons in the selected floor area and its relative received signal strength indication (RSSI) values from main server system metadata. The method may comprise a seventh step of generating, via the program executed by the processor, position coordinates for relative received signal strength indication (RSSI) and the floor metadata of destination area (B). The method may comprise an eighth step of navigating, via the program executed by the processor, to accurate coordinates from previous coordinates and pointing on a display screen of the user navigation device.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates an indoor navigation system comprising a user navigation device (103), a server (101), a set of beacons (108) installed at an indoor navigation functioning area (104), in accordance with an embodiment of the present disclosure.

FIG. 2 illustrates the server (101) and its components in detail, in accordance with an embodiment of the present disclosure.

FIG. 3 illustrates, the user navigation device (103) displayed with an indoor map C, blue point A and destination point B, in accordance with an embodiment of the present disclosure.

FIG. 4 illustrates, a method of BLE (Bluetooth low energy) based indoor navigation), in accordance with an embodiment of the present disclosure.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items.

It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are described. The disclosed embodiments are merely exemplary of the disclosure, which may be embodied in various forms.

Various modifications to the embodiment may be readily apparent to those skilled in the art and the generic principles herein may be applied to other embodiments. However, one of ordinary skill in the art may readily recognize that the present disclosure is not intended to be limited to the embodiments illustrated but is to be accorded the widest scope consistent with the principles and features described herein.

The present disclosure solves the problem of location based indoor navigation system enabled by BLE (Bluetooth Low energy) beacon systems. In other words, the present subject matter is related to Bluetooth based integrated indoor navigation system.

The embodiments of present disclosure may provide an indoor navigation platform to a user through communication transmitter as Bluetooth 4.0, Bluetooth 4.1, Bluetooth 4.2, Bluetooth Low Energy (BLE), other versions of Bluetooth low energy beacons, and other similar technologies. The communicating BLE beacons work with mechanisms such as triangulation, proximity recognition and three or less than three trilateration. The Beacons (alternately referred as “BLE beacons”) of indoor navigation are arranged in such way that the beacons are attached to the ceiling of the premises with a specified height. Such Beacons are configured with a server system and a user navigation device display.

The indoor navigation system may be configured to provide indoor navigation in one or more but not limited to selected zone areas of an infrastructure, wherein the infrastructure may comprise office, retail, shopping malls, school, stadium, hospital, airport, selected zone, restricted land areas, and confined zone areas.

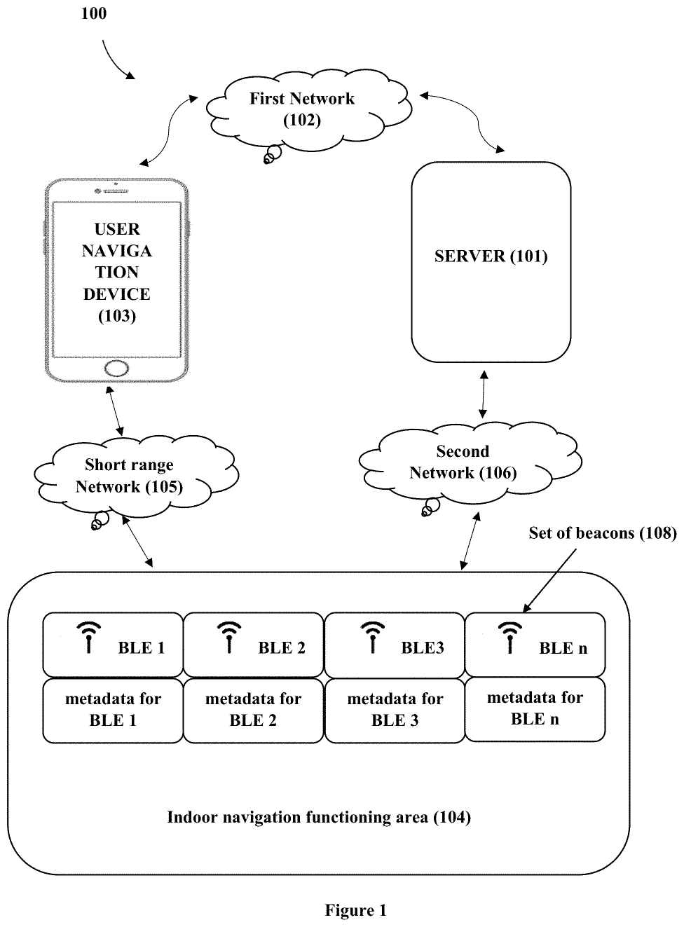

FIG. 1 illustrates an indoor navigation system hereafter referred to as a system (100) for BLE (Bluetooth Low Energy) based indoor navigation in accordance with an embodiment of the present disclosure. The system (100) comprises a frontend user navigation device (103),—a first network (102), a server (101), a second network (106), a short-range network (105) and an indoor navigation functioning area (104). The 3-dimensional area (104) hereafter referred to as indoor navigation functioning area (104) further comprises one or more BLE beacons (108) covering a particular location area of the indoor navigation functioning area (104), and wherein each BLE beacon in the respective location area is mounted on a ceiling or walls of the respective location area.

Referring now to FIG. 1, the server (101) may comprise an indoor navigation platform for functioning/operating indoor navigation tasks for the indoor navigation functioning area (104). As shown in FIG. 1, the indoor navigation functioning area (104) may further comprise a set of BLE beacons (108) mounted in the areas/3-dimensional space, such as BLE location area 1, BLE location area 2, BLE location area 3 . . . BLE location area n. It must be noted that the 3-dimensional space can be a narrow-elongated passage, or a closed space with different height and dimensions. In one embodiment, the distance between the set of beacons is kept constant.

In one embodiment, corresponding to each of the BLE location areas, metadata may be generated, wherein the metadata includes area/zone data, proximity data, signal strength data in combination with position data. In one example, as shown in FIG. 1, metadata corresponding to the BLE location area 1, the BLE location area 2, the BLE location area 3 . . . BLE location area n, metadata for BLE 1, metadata for BLE 2, metadata for BLE 3 up and metadata for BLE n may be generated. Further, the metadata of the indoor navigation functioning area is stored in the server (101). The metadata and other information related to and required for indoor navigation functioning area is stored and further processed via the server (101). Further, the metadata and the other information is further communicated to the processor of the user navigation device (103). The user navigation device may utilize the metadata and the other information for managing location, proximity, navigation, and navigation path display related functions and operations configured for the user.

In one embodiment, the BLE location area may correspond to an elongated narrow space, wherein the set of beacons (108) are arranged along a line in the 3-dimensional area (104). In such spaces, bilateral positioning is performed to determine the location coordinates of the user navigation device (103) in case of linear movement of the user navigation device (103) in the 3-dimensional area (104). The bilateral positioning is performed by using RSSI data of two beacons nearest to the user navigation device (103).

In one embodiment, the BLE location area may correspond to a rectangular or squared space, wherein the set of sensors are arranged along the grid of the 3-dimensional area (104).

In such spaces, trilateral and multilateral positioning is performed by using a subset of beacons nearest to the user navigation device (103).

In one embodiment, the user navigation device (103) may be one of a frontend user navigation device or an admin panel of the user navigation system. The frontend user navigation device may be accessed by a frontend user. Further, the admin panel user navigation system may be a monitory panel system for administrating the task and operations access provided to the front-end user.

In one embodiment, the user navigation device (103) may be enabled with an accelerometer (not shown). The accelerometer within the user navigation device (103) determines the height at which the user navigation device is located above a surface in 3-dimensional area (104).

In one implementation, the accelerometer of the user navigation device (103) may be configured to determine height difference between the set of beacons (108) in indoor navigation functioning area (104) and the user navigation device (103) for improved accuracy in determining the user's location. In one embodiment, the accelerometer data in combination with velocity data of the user may be analyzed in order to determine size of steps taken by the user during the user's movement in the indoor navigation functioning area (104). The step size can be used to determine the height of the user as well as height of the user navigation device from the floor of the indoor navigation functioning area (104). This height data can then be used for triangulation and determining the exact position of the user in the indoor navigation functioning area (104). For example, in an indoor office space, there can be many narrow passages separated by partitions. Whether the user in on the right side of the partition or left side of the partition cannot be determined just by using beacon data of two beacons in case of the bilateral positioning. Also, the floor at which the user is currently positioned cannot be determined from the beacon data. In such situations, height of the user navigation device (103) from the ground can be used for triangulation. Direction of travel of the user can also be used in combination with the RSSI data and accelerometer data in order to determine the exact location of the user.

In one embodiment, the user navigation device (103) may have a magnetometer sensor embedded in the device, wherein a magnetometer sensor is used by the user navigation device (103) for determining the orientation of the user navigation device (103) of the user. This orientation data may be used for generating a map for guiding the user to reach the specified destination.

In one implementation, the first network (102) may be a wireless network, a wired network or a combination thereof for facilitating communication between the user navigation device (103) and the server (101). In one implementation, the second network (106) may be a wireless network, a wired network or a combination thereof for facilitating communication between the Bluetooth beacons of indoor navigation functioning area (104) and the server (101). In one implementation the first network (102) and the second network (106) may be same or a part of a same communication network and network type.

The first network (102), or the second network, (106) may be implemented as one of the different types of networks, such as cellular intranet, local area network (LAN), wide area network (WAN), the internet, short range network, Bluetooth, Bluetooth Low energy (BLE) and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network may include a variety of network devices, including routers, bridges, servers, computing devices, storage devices, and the like.

In one implementation the short-range network (105) may be a wireless network for facilitating network communication between the user navigation device (103) and each Bluetooth beacons of indoor navigation functioning area (104). In one embodiment, the short-range communication network (105) may be a BLE (Bluetooth Low Energy) communication network.

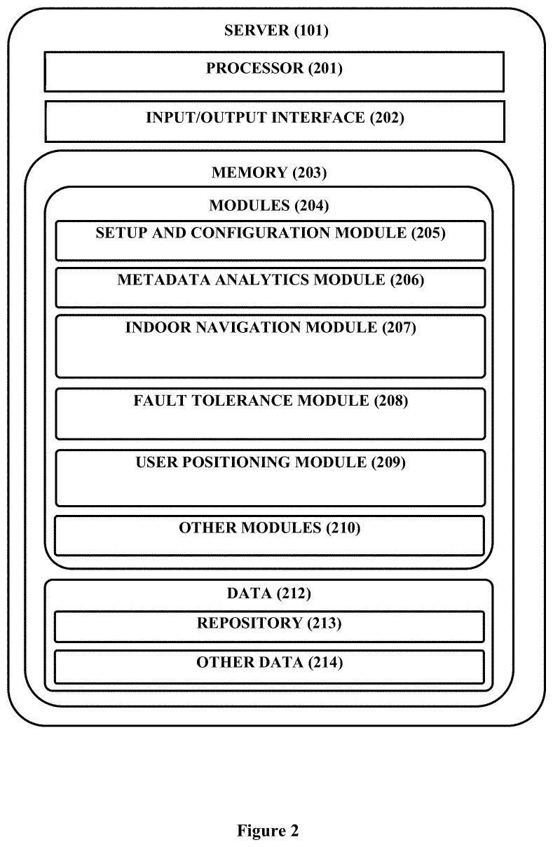

FIG. 2 illustrates a server (101) in accordance with an embodiment of the present disclosure. The server (101) may comprise a processor (201), an Input/Output (I/O) interface (201), a memory (203), data (212), repository (213), other data (214) and modules (204).

The processor (201) may be implemented as one or more microprocessors, microcomputers, microcontrollers, digital signal processors, central processing units, state machines, logic circuitries, and/or any devices that manipulate signals based on operational instructions. Among other capabilities, the processor (201) is configured to fetch and execute computer-readable instructions stored in the memory (203).

Referring to FIG. 2 an (I/O) interface (202) may include a variety of software and hardware interfaces, for example, a web interface, a user interface, a graphical user interface, and the like. The I/O interface (202) may allow the system (101) to interact with a user directly or through the electronic devices. Further, the I/O interface (202) may enable the system (101) to communicate with other computing devices, such as web servers and external data servers (not shown). The I/O interface (202), can facilitate multiple communications within a wide variety of networks and protocol types, including wired networks, for example, LAN, cable, etc., and wireless networks, such as WLAN, cellular, Bluetooth beacons, Bluetooth low energy or satellite. The I/O interface (202) may include one or more ports for connecting a number of devices to one another or to another server.

The memory (203) may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory (203) may further include modules (204) for performing particular tasks.

The modules may include routines, programs, objects, components, data structures, etc., which perform particular tasks or implement particular abstract data types.

In one implementation, the modules (204) may comprise a setup and configuration module (205), a metadata analytics module (206), an indoor navigation module (207), fault tolerance module (208), and a user positioning module (209).

In one embodiment, the setup and configuration module (205) may be configured for configuring the user navigation device (103) with floor maps and navigation map interface. Further, the metadata analytics module (206) may be configured for performing operations such as scanning and placing beacons on the map, generating floor metadata on the frontend user interface, uploading the floor metadata to the memory (203) of server (101), and enabling download of specific floor meta data to the front-end user navigation device (103).

In one implementation, the indoor navigation module (207) may be configured for navigating the user through number of zones of the functioning area in targeted infrastructure. Further, the indoor navigation module (207) may be configured for notifying and recommending a shorter route, identifying empty areas and specifying zones such as desk area, pantry area, restroom area, emergency exit area etc., based on data analytics. The indoor navigation module (207) may be further configured for indicating current location of the user by notifying the zone proximity information to the user.

In one implementation, the fault tolerance module (208) may be configured for performing operations such as, searching of BLE beacons and obtaining relative received signal strength indication (RSSI) values corresponding to each BLE beacon. In one scenario, relative received signal strength indication (RSSI) may vary even for fixed position of the user or the user navigation device (103).

The fault tolerance algorithm may provide a statistical way to obtain accurate relative received signal strength indication (RSSI) values by repeating relative received signal strength indication (RSSI) readings. The fault tolerance module (208) may further be configured for performing a task of generating position co-ordinates from the received relative received signal strength indication (RSSI) repetitive reading values by statistical methods. The statistical method used for calculating position co-ordinates may be a fault tolerance algorithm method. The calculated position coordinate data is analyzed by the fault tolerance module (208) in order to avoid environmental and device related distortion. A deployment of beacons may take place in linear as well as grid fashion. The fault tolerance module (208) is further configured to overcome the common limitation of not being able to identify 2D coordinates of the user navigation device (103), as the fault tolerance algorithm provides x-y co-ordinate tracking in plane.

In one embodiment, the fault tolerance module (208) may be configured to provide a statistical way (fault tolerance algorithm) in order to obtain accurate range of relative received signal strength indication (RSSI) as fault tolerance module (208) is tolerant to environment, signal strength and specific signal distortion.

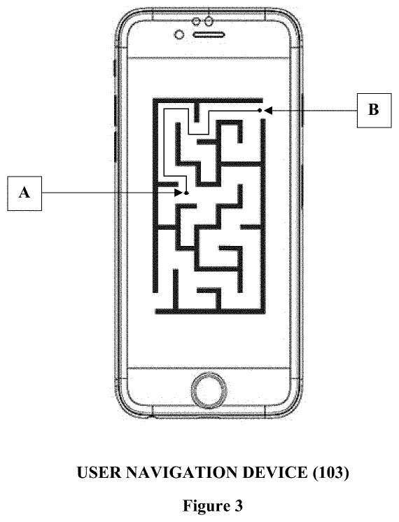

In one implementation, the user positioning module (209) may be configured to provide final outcome in form of co-ordinates of the user navigation device (103) that is displayed as a Blue dot (position A) and a destination position (B) on the display of the user navigation device (103) as shown in FIG. 3. The user positioning module (209) may be further configured to implement 3D trilateration techniques, considering height or distance of the BLE beacon from the user. The planer trilateration techniques known in the art are based only on distance approximation of BLE beacons from user and the height of the BLE beacons above the user may be ignored. The user positioning module (209) may be further configured to implement 3D trilateration in the 3D space between the BLE beacons and the user navigation device (103). The user positioning module (209) may also be further configured to measure the Z coordinate values enabling accuracy in the positioning of user navigation device (103) using BLE beacons mounted to the indoor navigation functioning area (104).

In one implementation the modules (204) may comprise other modules (211) to manage additional tasks similar to the functions described by above described modules.

FIG. 3 illustrates, the user navigation device (103) displayed with an indoor map C, blue point A and destination point B, in accordance with an embodiment of the present disclosure.

Referring to FIG. 3, the indoor map C of the 3-dimensional indoor navigation functioning area (104) is displayed on the screen for navigating the user from point A to destination point B.

In one embodiment, the location of the user navigation device (103) in the 3-dimensional moveable indoor navigation functioning area (104) is plotted and displayed by a marker on the display screen of the user navigation device (103), which discloses the orientation of the device and the user.

In one embodiment, user's location is displayed on the display screen with a marker having a directional arrow pointing in the direction of the device or user based on the determined orientation of the device or the user via the magnetometer sensor.

It may be understood that the system (101), may also be implemented in a variety of computing systems, such as a laptop computer, a desktop computer, a notebook, a workstation, a mainframe computer, a server, a network server, mobile, cell phone, tablet, smart phone, user interface with display, flash drive and the like. It may be understood that the system (101) may be accessed by multiple electronic devices. Examples of the electronic device may include, but not limited to, a portable computer, a personal digital assistant, a handheld device, a user device, mobile, smart phone and a workstation.

In one embodiment, communication modes may be a Bluetooth beacon network, BLE network, Bluetooth 4.0 network, Bluetooth 4.1 network, Bluetooth 4.2 network, wireless network, a wired network or a combination thereof. The communication mode can be implemented as one of the different types of networks, such as intranet, local area network (LAN), wide area network (WAN), the Internet, and the like. The communication mode may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), Handshake Protocol, Full Duplex Communication Algorithm, and the like, to communicate with one another. Further the communication mode network may include a variety of network devices, including routers, bridges, servers, computing devices, storage devices, and the like.

The user navigation device (103) may be configured to the system (101) in such a way that, it may be enabled to perform tasks such as, connecting the user navigation device (103) to the server (101). The user navigation device (103) may be configured selecting a floor map. The user navigation device (103) may be configured to scanning and placing beacons on the map. The user navigation device (103) may be configured for generating and uploading the floor metadata to the server (101). The user navigation device (103) may be configured for downloading floor metadata from server system (101). The user navigation device (103) may be configured for searching (406), beacons in the proximal area of user device. The user navigation device (103) may be further configured for generating (407) relative received signal strength indication (RSSI) values. The user navigation device (103) may be configured for navigating (408) through position co-ordinates based on relative received signal strength indication (RSSI) values.

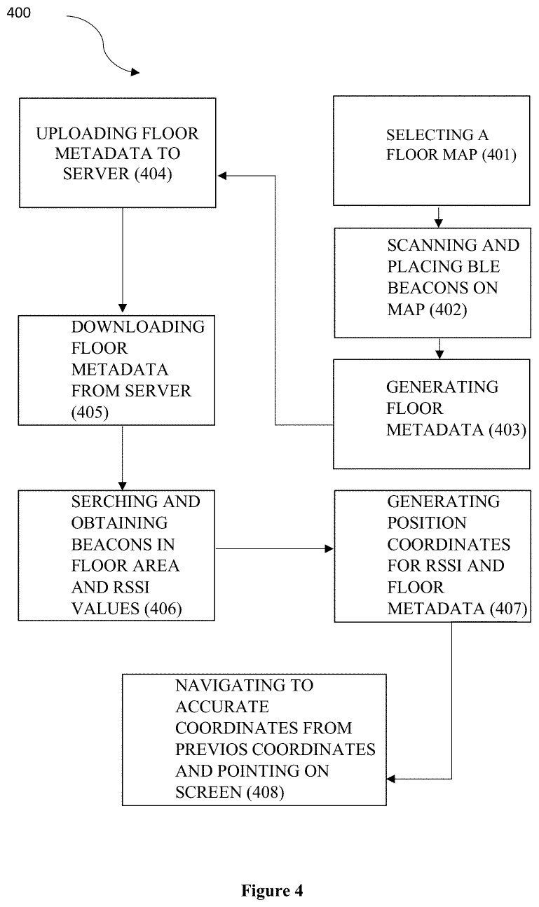

Referring to a FIG. 4, FIG. 4 discloses method (400) of implementation of overall system implementation (100) via a processor.

The method may comprise a first step of selecting (401), via the program executed by the processor, a floor map (not shown in figure) for which the navigation is to be carried out. The method may comprise a second step of scanning (402), via the program executed by the processor, and placing the position coordinates of BLE beacons attached to the ceiling on the display of map. The method may comprise a third step of generating a floor metadata (403), via the program executed by the processor, wherein the floor metadata comprises area/zone data, proximity data, signal strength data in combination with position data and referred as metadata. The method comprises a fourth step of uploading (404), via the program executed by the processor, the generated metadata to the server system (101). The method may comprise a fifth step of downloading (405), via the program executed by the processor, the floor metadata from server to the user navigation device (103). The method may comprise a sixth step of, searching and obtaining (406), via the program executed by the processor, BLE beacons in the selected floor area and its relative received signal strength indication (RSSI) values from the metadata stored in the server system (101). The method may comprise a seventh step of generating (407), via the program executed by the processor, position coordinates for relative received signal strength indication (RSSI) and the floor metadata of the destination area (B). The method may comprise an eighth step of navigating (408), via the program executed by the processor, to accurate coordinates from previous coordinates and pointing on a display screen of the user navigation device (103).

In an exemplary embodiment, the indoor navigation and system (100) may be implemented to the Indoor Navigation, Outdoor Navigation and Geo-fencing through Google Maps integration, Pantry Management, ordering the food from indoor pantry, location based notification management of the targeted infrastructure, proximity based information about the location, product, exhibit, tracking of vulnerable population like patients, children in the confined area, and visitor navigation systems.

In one exemplary embodiment the indoor navigation system may be implemented in institutions and organization such as, but not limited to schools, hospitals, multistory companies, workspaces, resorts, shopping malls etc.

In accordance with embodiments of the present disclosure, a system for an integrated indoor navigation described above may have following advantages including but not limited to:
Deployment of beacons in linear as well as grid fashion overcoming the common limitation of not being able to identify 2D coordinates enabling x-y coordinate tracking of user in plane.
Indoor navigation with fault tolerance algorithm as the RSSI level varies even for fixed position of user. Fault tolerance algorithm may provide a statistical way of getting correct range of RSSI from repeated RSSI readings.
Indoor navigation with better accuracy and tolerance to environment and specific signal distortion.
Improved trilateration techniques when distance/height of BLE is taken into consideration, as in case of 3D trilateration, the 3D space of beacons and user device are accurately analyzed considering the z coordinate values by using accelerometer data obtained from the user navigation device.
The indoor navigation system can work with less than three trilateration beacons.

The embodiments, examples and alternatives of the preceding paragraphs or the description and drawings, including any of their various aspects or respective individual features, may be taken independently or in any combination. Features described in connection with one embodiment are applicable to all embodiments, unless such features are incompatible.

The foregoing description shall be interpreted as illustrative and not in any limiting sense. A person of ordinary skill in the art would understand that certain modifications could come within the scope of this disclosure. For limiting the scope of the invention, a subsequent Complete Specification be filed to determine the true scope and content of this disclosure.

1. An indoor navigation system (100) comprising:
a user navigation device (103),
a first network (102),
a second network (106),
a short-range network (105) and a server (101) comprising a memory (203) coupled with a processor (201), wherein the processor (201) is configured to execute programmed instructions stored in the memory (203) for:
receiving RSSI data and floor metadata from a user navigation device (103), wherein the user navigation device (103) is configured to receive the RSSI data from a subset of beacons of a set of beacons (108), wherein the set of beacons (108) are installed along a 3-dimensional area (104) in a facility;
receiving acceleration data from an accelerometer of the user navigation device (103);
determining location coordinates of the user navigation device (103) in the 3-dimensional area (104) by processing the received RSSI data and the floor metadata based on acceleration data; and
transmitting the location coordinates to the user navigation device (103), wherein the user navigation device (103), upon receipt of the location coordinates, is configured to generate navigation instructions for assisting the user of the user navigation device (103) to reach a destination location in the 3-dimensional area (104).

2. The indoor navigation system (100) as claimed in claim 1, wherein the set of sensors are arranged along a line in the 3-dimensional area (104) when the 3-dimensional area (104) is an elongated narrow space, wherein bilateral positioning is performed to determine the location coordinates of the user navigation device (103) in case of linear movement of the user navigation device (103) in the 3-dimensional area (104), herein the bilateral positioning is performed using RSSI data of two beacons nearest to the user navigation device (103).

3. The indoor navigation system (100) as claimed in claim 1, wherein trilateral and multilateral positioning is performed when the 3-dimensional area (104) is a rectangular or squared in shape, wherein trilateral and multilateral positioning is performed by using three or more beacons nearest to the user navigation device (103).

4. The indoor navigation system (100) as claimed in claim 1, wherein floor metadata includes area/zone data, proximity data in combination with position data.

5. The indoor navigation system (100) as claimed in claim 1, wherein the accelerometer determines the height at which the user navigation device is located above a surface in 3-dimensional area (104).

6. The indoor navigation system (100) as claimed in claim 1, wherein plotting the location of the user navigation device (103) in the 3-dimensional moveable indoor navigation functioning area (104) is accomplished by displaying a marker on the display screen of the user navigation device (103) which discloses the orientation of the device and the user, wherein a magnetometer sensor is used by the user navigation device (103) for determining the orientation of the device and the user.

7. The indoor navigation system (100) as claimed in claim 6, wherein the user's location is displayed on the display screen with a marker having a directional arrow pointing in the direction of the device or user based on the determined orientation of the device or the user via the magnetometer sensor.

8. The indoor navigation system (100) as claimed in claim 1, wherein the accelerometer is configured to determine height difference between the set of beacons (108) in indoor navigation functioning area (104) and the user navigation device (103) for improved accuracy in determining the user's location.

9. A method for indoor navigation comprising:
receiving RSSI data and floor metadata from a user navigation device (103), wherein the user navigation device (103) is configured to receive the RSSI data from a subset of beacons of a set of beacons (108), wherein the set of beacons (108) are installed along a 3-dimensional area (104) in a facility;
receiving acceleration data from an accelerometer of the user navigation device (103);
determining location coordinates of the user navigation device (103) in the 3-dimensional area (104) by processing the received RSSI data and the floor metadata based on acceleration data; and
transmitting the location coordinates to the user navigation device (103), wherein the user navigation device (103), upon receipt of the location coordinates, is configured to generate navigation instructions for assisting the user of the user navigation device (103) to reach a destination location in the 3-dimensional area (104).
